(19) United States
(12) Patent Application Publication
(10) Pub. No.: US 2008/0038432 A1
(43) Pub. Date: Feb. 14, 2008

(54) Food Additive Comprising at Least One Fiber Source and at Least One Monosaccharide or Sugar Alcohol

(76) Inventors: Andrew J. Hoffman, Mount Zion, IL (US); Michael D. Harrison, Decatur, IL (US)

Correspondence Address: WILLIAMS, MORGAN & AMERSON, 10333 RICHMOND, SUITE 1100, HOUSTON, TX, 77042, US

(21) Appl. No.: 11/464,281

(22) Filed: Aug. 14, 2006

(51) Int. Cl. A23L 1/236

(52) U.S. Cl. 426/548

(57) ABSTRACT

We disclose a food additive containing at least one fiber source and at least one monosaccharide or sugar alcohol selected from the group consisting of fructose and sorbitol. We also disclose a fiber-fortified foodstuff containing a base foodstuff; and the food additive. In addition, we disclose a method of fiber-fortifying a foodstuff by blending into the base foodstuff the food additive.

### BACKGROUND OF THE INVENTION

The present invention relates generally to the field of fiber fortification of foodstuffs. More particularly, it concerns fiber fortification of foodstuffs in a manner that imparts low glycemic response to the foodstuffs.

Fiber consumption in the United States and other developed countries is lower than is recommended by nutritional experts. Fiber, by which is meant both insoluble fiber, such as cellulose or related materials, and soluble fiber, by which is meant water-soluble carbohydrate materials at least partially indigestible by man, assists in gastrointestinal function and may lower the risk of developing type II diabetes, heart disease, high cholesterol, or obesity. The United States recommended daily value for fiber consumption for a person eating a 2000 calorie/day diet is 25 g, but it is estimated the average United States resident only consumes about 14-15 g per day. Therefore, it is desirable to have compositions capable of imparting dietary fiber to foodstuffs.

In addition, there is a great deal of interest, both from diabetics and their health care practitioners and from those, for reasons of health and fitness, otherwise concerned about the typical high-glycemic diet in the United States and other developed countries, in foodstuffs that have a low glycemic response. Therefore, it is desirable to have compositions capable of imparting a low glycemic response to foodstuffs.

### SUMMARY OF THE INVENTION

In one embodiment, the present invention relates to a food additive containing at least one fiber source and at least one monosaccharide or sugar alcohol selected from the group consisting of fructose and sorbitol.

In another embodiment, the present invention relates to a fiber-fortified foodstuff containing a base foodstuff, at least one fiber source, and at least one monosaccharide or sugar alcohol selected from the group consisting of fructose and sorbitol.

In another embodiment, the present invention relates to a method of fiber-fortifying a foodstuff by blending into a base foodstuff a food additive comprising at least one fiber source and at least one monosaccharide or sugar alcohol selected from the group consisting of fructose and sorbitol, to yield the fiber-fortified foodstuff.

The compositions and methods can impart dietary fiber and a relatively low glycemic response to foodstuffs.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1. Change in blood glucose concentrations over time for dogs fed maltodextrin or fructose, according to the canine glycemic response testing protocol described below.

FIG. 2. Change in blood glucose concentrations for dogs fed maltodextrin and a low molecular weight digestion resistant oligo- and polysaccharides formulation (version 1), according to the canine glycemic response testing protocol described below.

FIG. 3. Change in blood glucose concentrations over time for dogs fed maltodextrin, 25% fructose in low molecular weight digestion resistant oligo- and polysaccharides version 1 and 50% fructose in version 1, according to the canine glycemic response testing protocol described below.

FIG. 4. Change in blood glucose concentrations over time for dogs fed maltodextrin, 25% pullulan in version 1, and pullulan, according to the canine glycemic response testing protocol described below.

FIG. 5. Change in blood glucose concentrations over time for dogs fed maltodextrin and 50% sorbitol in version 1, according to the canine glycemic response testing protocol described below.

FIG. 6. Change in blood glucose concentrations over time for dogs fed maltodextrin, a second low molecular weight digestion resistant oligo- and polysaccharides formulation (version 2), and a third low molecular weight digestion resistant oligo- and polysaccharides formulation (version 3), according to the canine glycemic response testing protocol described below.

### DESCRIPTION OF ILLUSTRATIVE EMBODIMENTS

In one embodiment, the present invention relates to a food additive containing at least one fiber source and at least one monosaccharide or sugar alcohol selected from the group consisting of fructose and sorbitol.

The term “food additive” encompasses any formulation of the materials intended for addition to a foodstuff or after addition to the foodstuff. Materials packaged together in a single outer container yet not necessarily mixed or otherwise combined prior to addition to a foodstuff may be considered a formulation intended for addition to a foodstuff.

Any fiber source can be used and can be a material that provides insoluble fiber, such as cellulose or related materials, or soluble fiber, by which is meant water-soluble carbohydrate materials at least partially indigestible by man. In one embodiment, the at least one fiber source is selected from the group consisting of digestion-resistant glucose syrup, digestion-resistant corn syrup, digestion-resistant glucose syrup solids, digestion-resistant corn syrup solids, digestion-resistant maltodextrin, and pullulan. These materials are water soluble, are generally perceived to have mild, innocuous flavors, and have little color compared to many other fiber sources.

“Digestion-resistant” means at least some dextrose linkages are non-linear linkages (i.e., are not α1→4 linkages). A glucose syrup is a carbohydrate material containing some mono- and disaccharides; syrup solids are the residue after dehydration of a syrup. A glucose syrup typically has a dextrose equivalence (DE) of greater than about 20. A maltodextrin is a carbohydrate material substantially free of mono- and disaccharides and typically having a DE less than about 20. The use of “glucose” in conjunction with the word “syrup” indicates that the carbohydrate material can be derived from any starch source, in contrast to the use of “corn,” which indicates the carbohydrate material is derived from cornstarch.

Herein, digestion-resistant glucose syrup, digestion-resistant corn syrup, digestion-resistant glucose syrup solids, digestion-resistant corn syrup solids, and digestion-resistant maltodextrin may be referred to generically as low molecular weight digestion resistant oligo- and polysaccharides. (“Low molecular weight,” in this context, means a carbohydrate material having an average molecular weight from about 360 da to about 3000 da).

Low molecular weight digestion resistant oligo- and polysaccharides can be prepared by techniques known in the art, such as the methods described by copending patent application U.S. Ser. No. 11/339,306, filed Jan. 25, 2006, which is hereby incorporated by reference.

To summarize, low molecular weight digestion resistant oligo- and polysaccharides can be prepared from a suitable starting material, examples of which include, but are not limited to, syrups made by hydrolysis of starch, such as dextrose greens syrup (i.e., recycle stream of mother liquor from dextrose monohydrate crystallization), other dextrose syrups, corn syrup, and solutions of maltodextrin. The starting material can be converted to nonlinear oligosaccharides by enzymatic reversion (such as by a glucoamylase enzyme composition or any other enzyme that acts on dextrose polymers) or acid reversion. Acid reversion can use any of a variety of acids, such as hydrochloric acid, sulfuric acid, phosphoric acid, or a combination thereof.

The acid treatment progresses differently than enzyme treatment. Enzymes rapidly hydrolyze linear oligomers and slowly form non-linear oligomers, whereas with acid the reduction in linear oligomers and the increase in non-linear oligomers occur at comparable rates. Dextrose is formed rapidly by enzymatic hydrolysis of oligomers, and consumed slowly as non-linear condensation products are formed, whereas with acid dextrose concentrations increase slowly before ultimately decreasing.

Optionally, enzymatic or acid reversion can be followed by hydrogenation. The hydrogenated product should have lower caloric content than currently available hydrogenated starch hydrolysates. In one embodiment, the hydrogenation can be used to decolorize the product composition without substantially changing its dextrose equivalence (DE). In another embodiment, the hydrogenation can be used to decrease the DE from a value of greater than about 10 to a value of less then about 10.

In one version of the process, enzyme and acid can be used sequentially, in any order.

The low molecular weight digestion resistant oligo- and polysaccharides described above can contain at least about 60 wt % d.s.b. indigestible oligosaccharides, and we have prepared formulations containing at least about 80 wt % d.s.b. indigestible oligosaccharides (defined herein as trisaccharides or higher-order oligosaccharides). The balance of low molecular weight digestion resistant oligo- and polysaccharides are primarily residual mono- and disaccharides. Exemplary low molecular weight digestion resistant oligo- and polysaccharides formulations of our preparation have from about 1.5 wt % d.s.b. to about 8.5 wt % d.s.b. monosaccharides, from about 3.5 wt % d.s.b. to about 4.5 wt % d.s.b. disaccharides, from about 4.0 wt % d.s.b. to about 4.5 wt % d.s.b. trisaccharides, and balance (from about 84 wt % d.s.b. to about 89 wt % d.s.b.) tetrasaccharides or higher-order oligosaccharides.

In another embodiment, the fiber source can be pullulan. In addition to providing fiber, pullulan, being relatively highly viscous, can improve the mouthfeel of a beverage containing a high intensity sweetener. This can be beneficial in promoting consumer acceptance of such beverages because the mouthfeel of the pullulan- and high-intensity-sweetener-containing beverage can more closely resemble that of a conventional sugar-containing beverage. A beverage containing a high-intensity-sweetener and having a pullulan concentration of about 0.5 wt % d.s.b. can have a viscosity at shear rates from about 10 sec-1 to about 100 sec-1 comparable to that of a beverage sweetened with sugar and free of pullulan, roughly 1.3-1.5 cP.

Two or more fiber sources can be used. In one embodiment, the food additive contains one or more low molecular weight digestion resistant oligo- and polysaccharides and pullulan. The combination of a higher molecular weight fiber source (higher than about 10,000 da, such as pullulan) and a lower molecular weight fiber source may provide improved dietary tolerance over a lower molecular weight fiber source alone in certain individuals.

Turning to the at least one monosaccharide or sugar alcohol, either fructose, sorbitol, or both can be used. The amount of total monosaccharides and sugar alcohols in the additive can range from about 15 wt % total monosaccharides and sugar alcohols to about 60 wt % total monosaccharides and sugar alcohols. The weight percentage is calculated over the total weight of fiber sources, monosaccharides, and sugar alcohols. Any further materials included in the additive (as will be described below) are not included in the calculation of weight percentage above.

The relative glycemic response (RGR) of a material, composition, or formulation, as used herein, is calculated as described in the examples below. In summary, the RGR is calculated by measuring the glycemic response of a material, composition, or formulation in a canine model and then normalizing to the glycemic response of 10 DE (dextrose equivalents) maltodextrin controls.

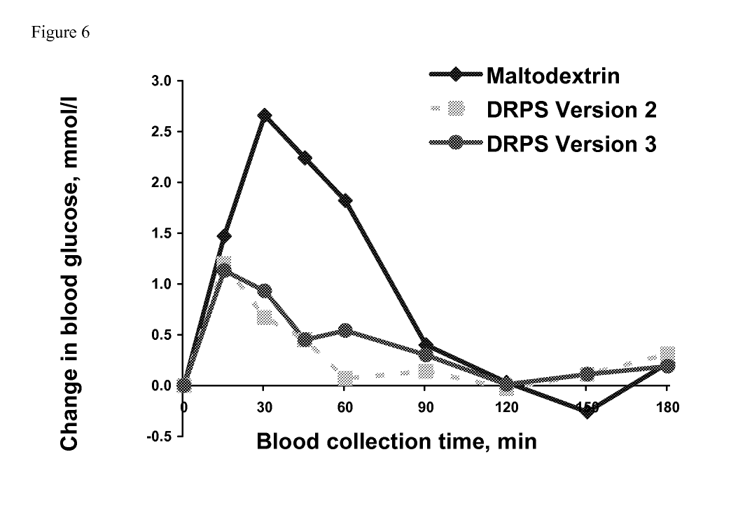

One or more low molecular weight digestion resistant oligo- and polysaccharides alone typically have an RGR of about 60%, although we have prepared formulations with RGR as low as about 25%. (See FIG. 6). Fructose alone has an RGR of about 3%. We have discovered that a material containing 25 wt % fructose (balance low molecular weight digestion resistant oligo- and polysaccharides) has an RGR of about 7%, which is far lower than the RGR that would be expected to result from simple mixing and dilution (about 18.25-45.75%). We have also discovered that a material containing 50 wt % sorbitol (balance low molecular weight digestion resistant oligo- and polysaccharides) has an RGR of about 6%, which is also lower than that expected to result from simple mixing and dilution.

In addition to the at least one fiber source and the at least one monosaccharide or sugar alcohol, the food additive can further contain other materials.

In one embodiment, the food additive further contains at least one sweetener. In one further embodiment, the sweetener is selected from the group consisting of sucralose, saccharin, aspartame, and acesulfame salts. The most commonly used acesulfame salt in the food industry in the United States at this writing is acesulfame potassium. Such sweeteners can impart a sweet taste to a foodstuff to which they are added with a negligible increase in the carbohydrate content, caloric content, RGR, or glycemic load thereof.

In one embodiment, the food additive further contains at least one acidulant. An acidulant is a material acceptable for human or animal consumption that lowers the pH of a foodstuff into which it is dissolved or mixed. In one embodiment, the acidulant can be selected from the group consisting of citric acid and malic acid.

In one embodiment, the food additive further contains at least one water-soluble carbonate or bicarbonate. On entering an aqueous solution, the water-soluble carbonate or bicarbonate imparts carbonation to the aqueous solution. The water-soluble carbonate or bicarbonate should be acceptable for human or animal consumption. In one embodiment, each at least one water-soluble carbonate or bicarbonate can be selected from the group consisting of sodium carbonate and calcium carbonate. In a further embodiment, the at least one water-soluble carbonate or bicarbonate can be sodium carbonate.

In another embodiment, the food additive further contains at least one flavorant. A flavorant is a material acceptable for human or animal consumption that imparts a flavor to a foodstuff into which it is dissolved or mixed. In one embodiment, each at least one flavorant is selected from the group consisting of lemon flavor, lime flavor, cherry flavor, strawberry flavor, banana flavor, blueberry flavor, grape flavor, watermelon flavor, orange flavor, apple flavor, peach flavor, raspberry flavor, chocolate flavor, vanilla flavor, bubble gum flavor, and licorice flavor.

In another embodiment, the food additive further contains at least one colorant. A colorant is a material acceptable for human or animal consumption that imparts a color to a foodstuff into which it is dissolved or mixed.

In another embodiment, the food additive further contains at least one preservative. A preservative is a material acceptable for human or animal consumption that protects other materials from attack by microbes, insects, or other pests.

Two or more of the further components listed above can be included in the food additive. For example, inclusion of citric acid, lemon flavor, and a sweetener in the food additive can impart a lemonade profile, along with dietary fiber, and with negligible RGR or glycemic load, to a beverage into which the food additive is mixed.

In one embodiment, the food additive has a relative glycemic response (RGR) less than about 10%. It should also be noted that the food additive will provide dietary fiber upon ingestion.

In another embodiment, the present invention relates to a fiber-fortified foodstuff containing a base foodstuff, at least one fiber source, and at least one monosaccharide or sugar alcohol selected from the group consisting of fructose and sorbitol.

A “base foodstuff” is any foodstuff for which fortification with fiber may be desired. “Foodstuff” and “base foodstuff” encompass any material, potable or comestible, intended for human or animal consumption. In one embodiment, the base foodstuff is selected from the group consisting of water, milk, fruit juices, vegetable juices, carbonated soft drinks, non-carbonated soft drinks, coffee, tea, beer, wine, liquor, alcoholic mixed drinks, processed foods such as bread, cakes, cookies, crackers, extruded snacks, soups, frozen desserts, fried foods, pasta products, potato products, rice products, corn products, wheat products, dairy products, yogurts, confectionaries, hard candies, nutritional bars, breakfast cereals, dough, dough mix, sauces, processed meats, and cheeses, among others. This list is not intended to be exhaustive.

The at least one fiber source and the at least one monosaccharide or sugar alcohol selected from the group consisting of fructose and sorbitol can be as described above. In one embodiment, the fiber-fortified foodstuff comprises at least about 2.5 g dietary fiber per serving derived from the total of all of the at least one fiber sources (in other words, 2.5 g dietary fiber in addition to any dietary fiber provided by the base foodstuff). In a further embodiment, the fiber-fortified foodstuff comprises at least about 3 g dietary fiber per serving derived from the total of all of the at least one fiber sources, such as at least about 4 g or at least about 5 g dietary fiber per serving derived from the total of all of the at least one fiber sources.

The glycemic load (GL) of a food is defined as its carbohydrate content in grams times its RGR. In one embodiment, the fiber-fortified foodstuff has a GL no more than 1 gram per serving greater than the GL of the base foodstuff.

In one embodiment, the base foodstuff is a carbonated soft drink, to which is added 5 g low molecular weight digestion resistant oligo- and polysaccharides and 25.7 g fructose to yield a carbonated soft drink supplying about 113 calories per 12 oz serving. The carbonated soft drink has an RGR of about 3% and a glycemic load of about 0.9 grams is delivered. Consumption of one serving of this beverage provides 3-4 g dietary fiber.

In another embodiment, the base foodstuff is a carbonated soft drink, to which is added 5 g low molecular weight digestion resistant oligo- and polysaccharides, 1.7 g fructose (RGR of this combination of ingredients is about 7%), and 0.06 g sucralose to provide sweetness. This beverage supplies about 17 calories per serving 12 oz serving. The product has a glycemic load of about 0.5 g. Consumption of one serving of this beverage provides 3-4 g dietary fiber.

In an example of a beverage containing pullulan, to the base foodstuff of a carbonated soft drink is added 2.3 g low molecular weight digestion resistant oligo- and polysaccharides and 1.8 g pullulan (0.5 wt %). Additionally, 0.06 g sucralose are added to provide sweetness to the cola beverage. Pullulan is included at 0.5% by weight in this beverage to add viscosity to mimic the mouthfeel of a full sugar beverage. More generally, from about 0.25 wt % d.s.b. to about 1.25 wt % d.s.b. pullulan provides the beverage with a rheology comparable to that of a full sugar beverage (about 10% d.s.b. sucrose or about 10% d.s.b. high fructose corn syrup) in water. This beverage supplies about 8.2 calories per 12 oz serving. This beverage has a glycemic load of about 1.2 grams and a glycemic response of about 30%. Consumption of one serving of this beverage provides about three grams of dietary fiber.

In another embodiment, the present invention relates to a method of fiber-fortifying a foodstuff by blending into a base foodstuff a food additive comprising at least one fiber source and at least one monosaccharide or sugar alcohol selected from the group consisting of fructose and sorbitol, to yield the fiber-fortified foodstuff.

The base foodstuff and the food additive can be as described above.

“Blending” means intimately mixing the base foodstuff and the food additive such that the foodstuff is rendered substantially homogeneous. It is not limited to the use of any particular apparatus useful in intimately mixing materials to substantial homogeneity. Techniques for blending food additives into base foodstuffs will vary depending on the base foodstuff and the phase and other physical parameters of the food additive. The skilled artisan having the benefit of the present disclosure can blend the food additive of the present invention into a base foodstuff as a matter of routine experimentation.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

Canine Glycemic Response Testing Protocol

Animals. Purpose-bred female dogs (n=5; Butler Farms USA, Clyde, N.Y.) with hound bloodlines, a mean initial body weight of 25.1 kg (range, 19.9 to 29.5 kg), and a mean age of 5 yr were used.

Dietary treatments. Experimental carbohydrates were grouped in sets of 4 and each set was compared to a maltodextrin control (Star-Dri 10). Dogs consumed 25-50 g of carbohydrate in approximately 240-mL deionized water for the meal tolerance test. The quantity of dose was measured using a disposable 60 cc syringe (without needle) and offered to dogs over a 10 min period. The amount to be consumed was based on the ability of the material to dissolve in 240-mL water. The same amount of all carbohydrates was dosed to all dogs within each 5×5 Latin Square. In order to get carbohydrate sources into solution/suspension, water and carbohydrate were mixed using a stir plate. Blood glucose measurements were only taken when the dog consumed all of the test carbohydrate within 10 min.

Three formulations of low molecular weight digestion resistant oligo- and polysaccharides were prepared. The wt % d.s.b. of monosaccharides, disaccharides, trisaccharides, and tetra- and higher order saccharides were as follows:

| Formulation | DP1 | DP2 | DP3 | DP4+ |
|---|---|---|---|---|
| Version 1 | 1.7 | 3.8 | 7.6 | 86.9 |
| Version 2 | 12.5 | 4.7 | 4.1 | 78.7 |
| Version 3 | 1.6 | 4.6 | 4.6 | 89.2 |

Experimental design. A series of 5×5 Latin square designs were used in which dogs were subjected to three separate 3 h meal tolerance tests. Tolerance tests were spaced 3-4 d apart. After 15 h of food deprivation, dogs consumed their allotted treatment.

All dogs were fed the same commercial diet (Iams Weight Control®; The Iams Co., Lewsburg, Ohio). The main ingredients of the diet were corn meal, chicken, ground whole grain sorghum, chicken by-product meal, ground whole grain barley, and fish meal. Water was available ad libitum. At 1700 h on the evening before each meal tolerance test, any remaining food was removed, and dogs were food-deprived for 15 h, during which time they consumed only water. The morning of the meal tolerance test, a blood sample was obtained from food-deprived dogs. Dogs then were dosed with the appropriate carbohydrate solution, and additional blood samples were taken at 15, 30, 45, 60, 90, 120, 150, and 180 min postprandially. Approximately 1-mL of blood was collected in a syringe via jugular or radial venipuncture. An aliquot of blood was taken immediately for glucose analysis.

Chemical analyses. Immediately following collection, blood samples were assayed for glucose by the glucose oxidase method utilizing a Precision-G Blood Glucose Testing System (Medisense, Inc., Bedford, Mass.). The precision of this testing system for the range of values obtained was 3.4 to 3.7% (coefficient of variation), as reported by the manufacturer.

Statistical analysis. Data for within each Latin Square were analyzed by the Mixed models procedure of SAS (SAS Institute, Cary, N.C.). The statistical model included the fixed effect of treatment and the random effects of animal and period. Treatment least squares means were compared using the Tukey method. A probability of P<0.05 was accepted as being statistically significant. Probabilities between 0.06 and 0.10 were referred to as trends.

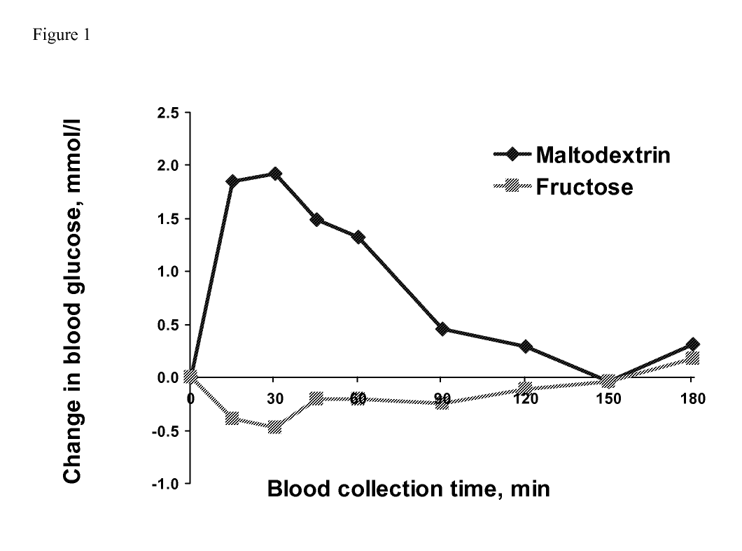

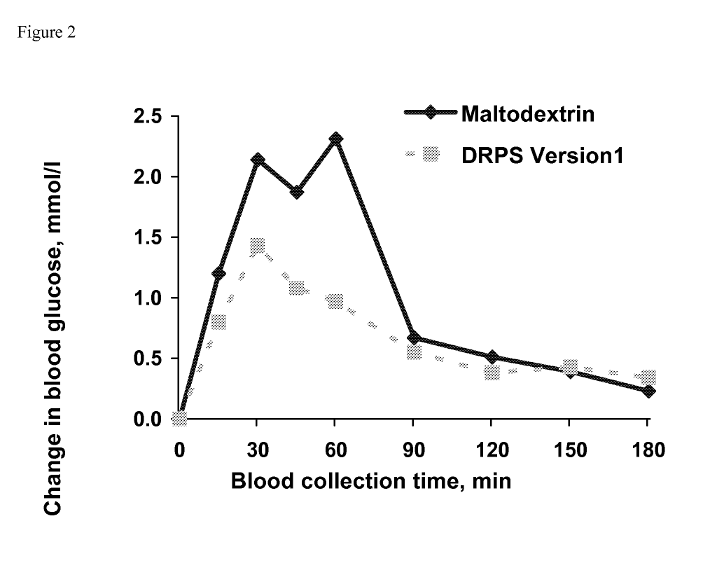

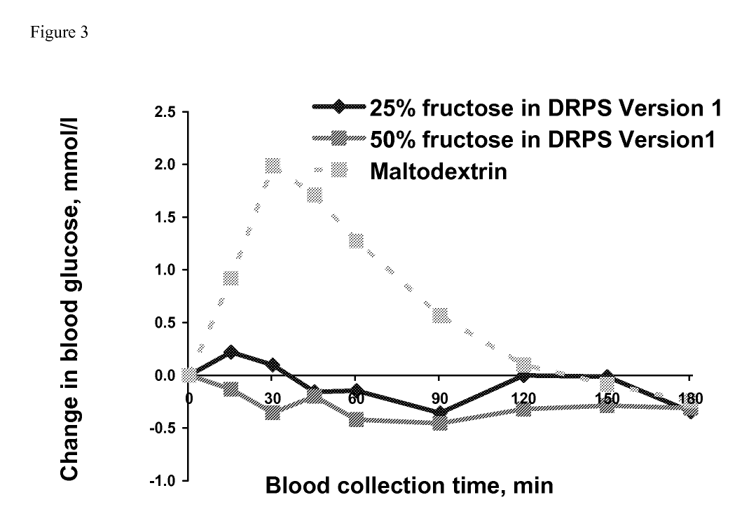

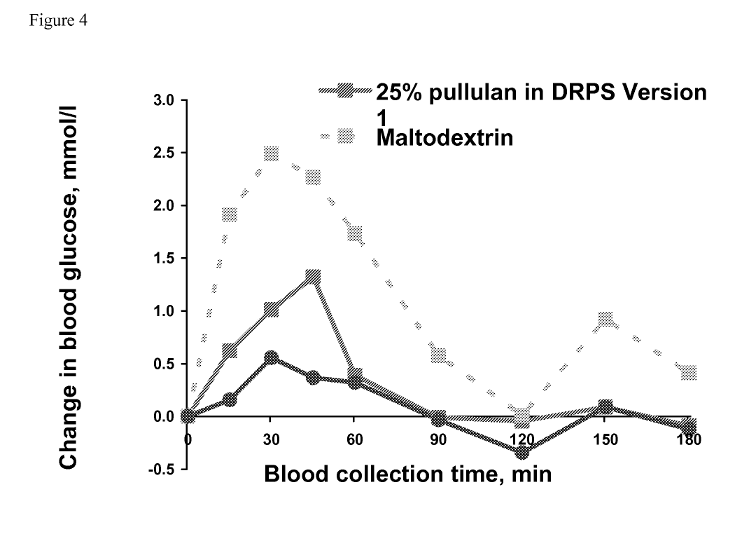

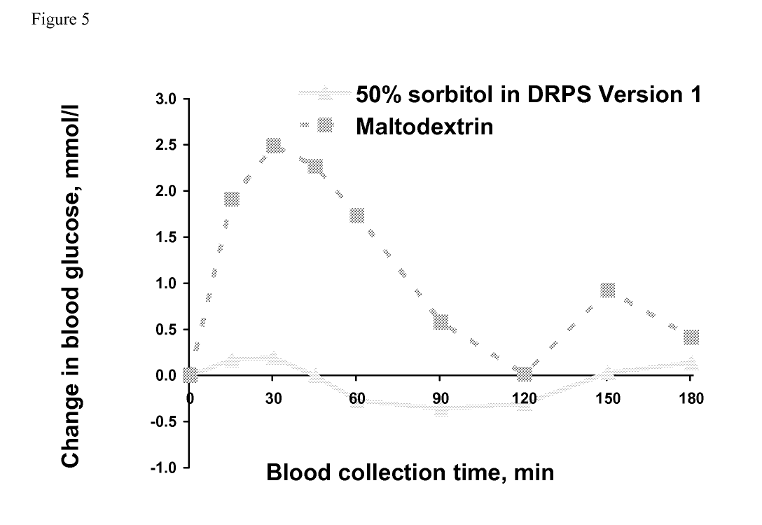

This protocol was used to generate the following six datasets (FIGS. 1-6 and Tables 1-6).

TABLE 1
Incremental area under the curve and relative glycemic response for
dogs fed maltodextrin or fructose.

| Item | Maltodextrin | Fructose | SEM |
|---|---|---|---|
| N | 5 | 5 | |
| Time to first peak, min | 45 | — | 17.4 |
| Incremental area under | 155.50^{c} | 4.67^{a} | 27.50 |
| the curve for glucose | | | |
| Relative glycemic | 100.00^{c} | 3.14^{a} | 19.51 |
| response | | | |

^{abc}Means in the same row with different superscripts are different (P < 0.05).

TABLE 2
Incremental area under the curve and relative glycemic response for
dogs fed maltodextrin and low molecular weight digestion resistant
oligo- and polysaccharides (version 1).

| Item | Maltodextrin | Version 1 | SEM |
|---|---|---|---|
| N | 5 | 5 | |
| Time to first peak, min | 45 | 33 | 12.2 |
| Incremental area under | 183.0^{c} | 115.3^{b} | 22.8 |
| the curve for glucose | | | |
| Relative glycemic | 100.0^{c} | 60.5^{b} | 11.9 |
| response | | | |

^{abc}Means in the same row with uncommon superscript are different (P < 0.05).

TABLE 3
Incremental area under the curve and relative glycemic response for
dogs fed maltodextrin, 25% fructose in version 1 and 50% fructose
in version 1.

| | | 25% | | |
|---|---|---|---|---|
| | | fructose in | 50% fructose in | |
| Item | Maltodextrin | version 1 | version 1 | SEM |
| N | 5 | 5 | 5 | |
| Time to glucose peak, | 27 | 22 | 42 | 19.9 |
| min | | | | |
| Incremental area under | 127.2^{c} | 7.8^{a} | 2.1^{a} | 11.08 |
| the curve for glucose | | | | |
| Relative glycemic | 100.0^{c} | 6.7^{a} | 2.1^{a} | 5.41 |
| response | | | | |

^{abc}Means in the same row with different superscripts are different (P < 0.05).

TABLE 4
Incremental area under the curve and relative glycemic response for
dogs fed maltodextrin, 25% pullulan in version 1, and pullulan.

| | | 25% pullulan in | | |
|---|---|---|---|---|
| Item | Maltodextrin | version 1 | Pullulan | SEM |
| N | 5 | 5 | 5 | |
| Time to glucose peak, | 35 | 39 | 33 | 13.4 |
| min | | | | |
| Incremental area under | 179.5^{c} | 54.1^{b} | 23.5^{ab} | 14.9 |
| the curve for glucose | | | | |
| Relative glycemic | 100.0^{d} | 31.3^{b} | 13.3^{a} | 3.9 |
| response | | | | |

^{abc}Means in the same row with different superscripts are different (P < 0.05).

TABLE 5
Incremental area under the curve and relative glycemic response for
dogs fed maltodextrin and 50% sorbitol in version 1.

| | | 50% | |
|---|---|---|---|
| Item | Maltodextrin | sorbitol in version 1 | SEM |
| N | 5 | 5 | |
| Time to glucose peak, min | 35 | 29 | 13.4 |
| Incremental area under the | 179.5^{c} | 9.6^{a} | 14.9 |
| curve for glucose | | | |
| Relative glycemic response | 100.0^{d} | 5.8^{a} | 3.9 |

^{abc}Means in the same row with different superscripts are different (P < 0.05).

TABLE 10
Incremental area under the curve and relative glycemic response for
dogs fed maltodextrin, low molecular weight digestion resistant oligo- and
polysaccharides version 2, and low molecular weight digestion resistant
oligo- and polysaccharides version 3.

| Item | Maltodextrin | version 2 | version 3 | SEM |
|---|---|---|---|---|
| N | 5 | 5 | 5 | |
| Time to glucose peak, min | 30 | 18 | 18 | 4.9 |
| Incremental area under the | 155.1^{d} | 37.7^{b} | 73.9^{c} | 12.9 |
| curve for glucose | | | | |
| Relative glycemic response | 100.0^{d} | 24.5^{b} | 50.1^{c} | 7.8 |

^{ab}Means in the same row with different superscripts are different (P < 0.05).

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A food additive, comprising:
at least one fiber source; and
at least one monosaccharide or sugar alcohol selected from the group consisting of fructose and sorbitol.

2. The food additive of claim 1, wherein the at least one fiber source is selected from the group consisting of digestion-resistant glucose syrup, digestion-resistant corn syrup, digestion-resistant glucose syrup solids, digestion-resistant corn syrup solids, digestion-resistant maltodextrin, and pullulan.

3. The food additive of claim 2, comprising (i) at least one fiber source selected from the group consisting of digestion-resistant glucose syrup, digestion-resistant corn syrup, digestion-resistant glucose syrup solids, digestion-resistant corn syrup solids, and digestion-resistant maltodextrin, and (ii) pullulan.

4. The food additive of claim 1, comprising from about 15 wt % total monosaccharides and sugar alcohols to about 60 wt % total monosaccharides and sugar alcohols.

5. The food additive of claim 1, wherein the food additive has a relative glycemic response (RGR) less than about 10%.

6. The food additive of claim 1, further comprising at least one sweetener.

7. The food additive of claim 6, wherein the sweetener is selected from the group consisting of sucralose, saccharin, aspartame, and acesulfame salts.

8. A fiber-fortified foodstuff, comprising:
a base foodstuff;
at least one fiber source; and
at least one monosaccharide or sugar alcohol selected from the group consisting of fructose and sorbitol.

9. The fiber-fortified foodstuff of claim 8, wherein the at least one fiber source is selected from the group consisting of digestion-resistant glucose syrup, digestion-resistant corn syrup, digestion-resistant glucose syrup solids, digestion-resistant corn syrup solids, digestion-resistant maltodextrin, and pullulan and the fiber-fortified foodstuff comprises at least about 2.5 g dietary fiber per serving derived from the total of all of the at least one fiber sources.

10. The fiber-fortified foodstuff of claim 9, comprising (i) at least one fiber source selected from the group consisting of digestion-resistant glucose syrup, digestion-resistant corn syrup, digestion-resistant glucose syrup solids, digestion-resistant corn syrup solids, and digestion-resistant maltodextrin, and (ii) pullulan.

11. The fiber-fortified foodstuff of claim 8, wherein the fiber-fortified foodstuff comprises from about 15 wt % total monosaccharides and sugar alcohols to about 60 wt % total monosaccharides and sugar alcohols relative to the total weight of all of the at least one fiber sources and all of the at least one monosaccharides and sugar alcohols.

12. The fiber-fortified foodstuff of claim 8, further comprising at least one sweetener selected from the group consisting of sucralose, saccharin, aspartame, and acesulfame salts.

13. The fiber-fortified foodstuff of claim 8, wherein the base foodstuff is selected from the group consisting of water, milk, fruit juices, vegetable juices, carbonated soft drinks, non-carbonated soft drinks, coffee, tea, beer, wine, liquor, alcoholic mixed drinks, processed foods such as bread, cakes, cookies, crackers, extruded snacks, soups, frozen desserts, fried foods, pasta products, potato products, rice products, corn products, wheat products, dairy products, yogurts, confectionaries, hard candies, nutritional bars, breakfast cereals, bread dough, bread dough mix, sauces, processed meats, and cheeses.

14. A method of fiber-fortifying a foodstuff, comprising:
blending into a base foodstuff a food additive comprising at least one fiber source and at least one monosaccharide or sugar alcohol selected from the group consisting of fructose and sorbitol, to yield the fiber-fortified foodstuff.

15. The method of claim 14, wherein the at least one fiber source is selected from the group consisting of digestion-resistant glucose syrup, digestion-resistant corn syrup, digestion-resistant glucose syrup solids, digestion-resistant corn syrup solids, digestion-resistant maltodextrin, and pullulan and the fiber-fortified foodstuff comprises at least about 2.5 g dietary fiber per serving derived from the total of all of the at least one fiber sources.

16. The method of claim 15, wherein the at least one fiber source is (i) at least one fiber source selected from the group consisting of digestion-resistant glucose syrup, digestion-resistant corn syrup, digestion-resistant glucose syrup solids, digestion-resistant corn syrup solids, and digestion-resistant maltodextrin, and (ii) pullulan.

17. The method of claim 14, wherein the fiber-fortified foodstuff comprises from about 15 wt % total monosaccharides and sugar alcohols to about 60 wt % total monosaccharides and sugar alcohols relative to the total weight of all of the at least one fiber sources and all of the at least one monosaccharides and sugar alcohols.

18. The method of claim 14, further comprises sweetening the fiber-fortified foodstuff with at least one sweetener selected from the group consisting of sucralose, saccharin, aspartame, and acesulfame salts.

19. The method of claim 14, wherein the base foodstuff is selected from the group consisting of water, milk, fruit juices, vegetable juices, carbonated soft drinks, non-carbonated soft drinks, coffee, tea, beer, wine, liquor, alcoholic mixed drinks, processed foods such as bread, cakes, cookies, crackers, extruded snacks, soups, frozen desserts, fried foods, pasta products, potato products, rice products, corn products, wheat products, dairy products, yogurts, confectionaries, hard candies, nutritional bars, breakfast cereals, bread dough, bread dough mix, sauces, processed meats, and cheeses.

20. A fiber-fortified beverage, comprising:
a base beverage;
from about 0.25 wt % d.s.b. to about 1.25 wt % d.s.b pullulan; and
at least one sweetener selected from the group consisting of sucralose, saccharin, aspartame, and acesulfame salts.
